(19) United States
(12) Patent Application Publication
(10) Pub. No.: US 2023/0058601 A1
(43) Pub. Date: Feb. 23, 2023

(54) SEEDED RESIN-STABILIZED HIGH-SOLIDS EMULSION POLYMERS

(71) Applicant: BASF SE, Ludwigshafen am Rhein (DE)

(72) Inventors: Roosevelt WHITE, Wyandotte, MI (US); Sean Raymond GEORGE, Wyandotte, MI (US); Joshua C. SPEROS, Wyandotte, MI (US); John David CAMPBELL, Hamilton (CA)

(21) Appl. No.: 17/785,930

(22) PCT Filed: Dec. 18, 2020
(86) PCT No.: PCT/EP2020/087062

§ 371 Date: Jun. 16, 2022

Related U.S. Application Data
(60) Provisional application No. 62/951,258, filed on Dec. 20, 2019.

(30) Foreign Application Priority Data
Feb. 26, 2020 (EP) 20159438.9

(51) Int. Cl. C08F 265/06

(52) U.S. Cl. CPC C08F 265/06

(57) ABSTRACT

The presently claimed invention relates to a polymer emulsion and a process for preparing a polymer emulsion. Particularly, the presently claimed invention relates to a process for preparing a polymer emulsion with high solids content.

### FIELD OF THE DISCLOSURE

The presently claimed invention relates to a polymer emulsion and a process for preparing a polymer emulsion. Particularly, the presently claimed invention relates to a process for preparing a polymer emulsion with high solids content.

### BACKGROUND

Stabilized polymer emulsions include widespread applications in the area of printing and packaging especially as adhesives. Due particularly to environmental regulations, there is an increasing demand for adhesives based on aqueous polymer emulsions with good performance properties, compared to conventional hot-melt and solvent-borne adhesives. More specifically, water-based adhesive systems have an advantage relative a reduction in organic solvents emissions.

During the preparation of adhesives, the aqueous medium is generally removed from the emulsion and the adhesives are subsequently cured and hardened at room temperature to form a bond which is desirably has a high strength and resistance to heat, humidity and water. However, a high-water fraction entails frequently an unwanted cost and complexity for the drying and filming of the aqueous systems. Therefore, there is a need for dispersions with as high as possible solids contents and low water contents which will provide faster setting times for use on high speed production equipment. Thus, one method to enhance the adhesive performance parameters such as speed of set, peel strength, water resistance and smoothness would be to increase the solids content of the emulsion. Moreover, there remains a need to balance the high solids content in the emulsions with the viscosity of the emulsion to maintain processability, i.e. so that it can be applied using conventional equipment.

Polymer emulsions are generally prepared by emulsion polymerization in the presence of nonpolymeric emulsifiers. Exemplary methodologies of preparation are described in U.S. Pat. Nos. 4,921,898; 5,070,134; and 5,629,370. The methods described in these patents are understood by those of ordinary skill not to be useful in the preparation of polymer emulsions with high solids content greater than about 65 wt. %.

Recently, polymer dispersions or polymer emulsions having a high solids content for coating have been investigated. For example, polymer emulsions with high solids content are known and described, for instance, in the following references.

U.S. 2015/0284482 describes a process for preparing an aqueous polymer dispersion having a high solids content wherein the dispersed polymer is prepared by radical emulsion polymerization in the presence of a polymer protective colloid.

U.S. 2007/0255000 describes an aqueous dispersion of polymer particles, the particles including: from 5% to 80% by weight, based on the weight of the polymeric particles, of a first polymer including at least one copolymerized ethylenically unsaturated monomer; and, substantially encapsulating the first polymer, from 20% to 95% by weight, based on the weight of the polymeric particles, of a second polymer including at least one copolymerized ethylenically unsaturated monomer, the second polymer having a Tg of from −40° C. to 30° C., wherein at least 90% by weight of the second polymer is formed by polymerization at a temperature of from 5° C. to 65° C.

EP 2 058 364 describes a composition comprising a water borne polymeric binder wherein said binder comprises from 0.05 wt. % to 20 wt. %, based on the total weight of polymer solids, carboxy acid monomers, present as copolymerized monomers in pendant polyacid sidechain groups, wherein the binder has a calculated Tg of between −50° C. and 80° C.; a filler, wherein on a dry weight basis the ratio of filler to polymer is from 1:1 to 10:1; and a thickener in an amount sufficient to achieve a shear thinnable composition that has a Brookfield viscosity of between 200,000 cps to 10,000,000 cps, when not under shear conditions, wherein the volume solids of the composition is between about 50% to about 75%.

U.S. Pat. No. 4,921,898 discloses a vinyl acetate ethylene copolymer emulsion which contains about 65% to 70% solids and has a viscosity of less than about 3,500 cps prepared in the presence of a stabilizing system.

Though these aforementioned references describe emulsions with high solids content, they have limitations. For example, they contain other components in the emulsion that are limiting the application properties of the emulsion. The emulsifiers or specific surfactant systems-based polymer emulsions show the undesired effect of negatively impacting the performance properties. In certain known embodiments, protective colloids are used in place of emulsifiers in the polymer emulsions, however these protective colloids have certain disadvantages, e.g. protective colloids are generally low molecular weight polymers containing acid groups, which become water soluble at elevated pH, when the acid groups are neutralized. Moreover, the disadvantage of these systems that include protective colloids resides in the presence of a large amount of stabilizer, thereby limiting the water resistance properties. Additionally, polymer emulsions containing protective colloids and having a high solid content of more than 55 wt. % often also have a disadvantage of poor rheological properties and are too highly viscous or no longer sufficiently fluid, and consequently are not suitable for coating on substrates.

Further improvements in this area include the use of block copolymers with distinct hydrophobic blocks and hydrophilic blocks. However, these systems have typically been limited to relatively low solids content of the emulsions, thereby limiting their usefulness for industrial applications.

Therefore, there is a clear need for improved polymer emulsions that are low in emulsifier content or almost free of emulsifiers and have a high solids content with improved performance properties. Hence, it is an object of the presently claimed invention to provide an improved process for preparing a polymer emulsion that overcomes the above-mentioned drawbacks and eliminates the need of surfactant to stabilize the polymer emulsion. Another object of the presently claimed invention is to provide a process for preparing a polymer emulsion with high solids content of greater than 55 wt. % that shows improved application properties compared to surfactant-based emulsions.

### SUMMARY OF THE DISCLOSURE

Surprisingly, it was found that by polymerizing a polymer seed, a polymerization mixture comprising at least one co-polymerizable monomer and a resin dispersion for preparing a polymer emulsion as disclosed herein results in polymer emulsions with a high solids content of at least 55 wt. %. Still further, by the process of preparing a polymer emulsion as disclosed herein, it is possible to achieve a polymer emulsion with low viscosity, in which the particles forming the emulsion show a bimodal or multimodal particle size distribution.

The invention is directed to a process for preparing a polymer emulsion which includes the steps of providing a resin dispersion having at least one resin in water and adding at least one polymer seed and a polymerization mixture to the resin dispersion. The polymerization mixture has at least one co-polymerizable monomer. The process includes preparing a polymer emulsion in water by radical emulsion polymerization of the polymerization mixture, the resin dispersion and the polymer seed. The polymer emulsion has a solids content of at least 55 wt. % based on the total weight of the polymer emulsion.

In accordance with another aspect of the presently claimed invention, a polymer emulsion is provided, that is obtainable by the process disclosed herein.

### DETAILED DESCRIPTION

The presently claimed invention is not to be limited in terms of the embodiments described in this application. Modifications and variations can be made without departing from its spirit and scope, as will be apparent to those skilled in the art. Functionally equivalent methods, formulations, and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to methods, reagents, compounds, or compositions, which can, of course, vary. It is also to be understood that the terminology used herein is for the purpose of describing embodiments only and is not intended to be limiting.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the subject matter described herein are capable of operation in other sequences than described or illustrated herein. In case the terms “(A)”, “(B)” and “(C)” or “(a)”, “(b)”, “(c)”, “(d)”, “(i)”, “(ii)” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

For the purposes of the presently claimed invention, where features or aspects of the disclosure are described in terms of Markush groups, those skilled in the art will recognize that the disclosure is also thereby described in terms of any individual member or subgroup of members of the Markush group.

For the purposes of the presently claimed invention, all ranges disclosed herein also encompass any and all possible subranges and combinations of subranges thereof. The ranges defined throughout the specification include the end values as well, i.e. a range of 1 to 10 implies that both 1 and 10 are included in the range. For the avoidance of doubt, the applicant shall be entitled to any equivalents according to applicable law. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

The term “about” used throughout this specification is used to describe and account for small fluctuations. For example, the term “about” refers to less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether explicitly indicated. A value modified by the term “about” of course includes the specific value. For instance, “about 5.0” must include 5.0.

In the following passages, different aspects of the subject matter are defined in more detail. Each aspect so defined may be combined with any other aspect or aspects unless clearly indicated to the contrary. Any feature indicated as being preferred or advantageous may be combined with any other feature or features indicated as being preferred or advantageous.

Reference throughout this specification to “one embodiment” or “an embodiment” means that a feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment but may refer. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the subject matter, and form different embodiments, as would be understood by those in the art. For example, in the appended claims, any of the claimed embodiments can be used in any combination.

Although the process disclosed herein has been described with reference to embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

For the purposes of the presently claimed invention, the term “polymer” refers to a single polymer or a mixture of polymers which comes about in a formation reaction from monomers to give macromolecules.

For the purposes of the presently claimed invention, “polymer emulsion” refers to an emulsion or a colloidal dispersion that comprises water-soluble and/or water-dispersible polymers.

For the purposes of the presently claimed invention, “resin dispersion” refers to a resin dispersed in water.

For the purposes of the presently claimed invention, “polymer seed” refers to polymers that act as a seed in polymerization.

For the purposes of the presently claimed invention, a surfactant is defined as a surface-active compound which decreases the surface tension of a liquid, the interfacial tension between two liquids, or that between a liquid and a solid. The term surfactant and emulsifier are interchangeable used herein.

For the purposes of the presently claimed invention, “water-soluble” means that the relevant component or ingredient of the composition can be dissolved in the aqueous phase on the molecular level.

For the purposes of the presently claimed invention, “water-dispersible” means that the relevant component or ingredient of the composition can be dispersed in the aqueous phase and forms a stable emulsion or a suspension.

For the purposes of the presently claimed invention, a binder or a solid binder is the non-volatile component of the polymer emulsion of the presently claimed invention, without pigments and fillers.

For the purposes of the presently claimed invention, the term “support resin” refers to a low molecular weight copolymer (weight average molecular weight of about 1500 g/mol to 35,000 g/mol) comprising styrene, acrylic and/or acidic monomers that can be dispersed in water upon neutralization of the acidic component.

For the purposes of the presently claimed invention, the term “aqueous” or “water-borne” as used herein refers to a significant fraction of water as the main dispersion medium besides organic solvents.

The use of (meth) in a monomer or repeat unit indicates an optional methyl group. The term “copolymer” means that the copolymer comprises block or random copolymers obtainable by radical polymerization.

For the purposes of the presently claimed invention, the term “bimodal particle size distribution” as used herein refers to two different groups of particle size distribution. For the purposes of the presently claimed invention, the term “multimodal particle size distribution” as used herein refers to more than two different groups of particle size distribution.

For the purposes of the presently claimed invention, the term “surfactant-free” is intended to mean that the polymerization was conducted without the use of a surfactant, and no surfactant was added to the composition at any time prior to, or during, formation of the emulsion.

For the purposes of the presently claimed invention, “theoretical glass transition temperature” or “theoretical Tg” refers to an estimated Tg of a polymer or a copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below, where wₐ is the weight fraction of monomer a in the copolymer, T_{ga} is the glass transition temperature of a homopolymer of monomer a, w_{b} is the weight fraction of monomer b in the copolymer, T_{gb} is the glass transition temperature of a homopolymer of monomer b, wᵢ is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

$$\frac{1}{{T}_{g}} = \frac{{w}_{a}}{{T}_{ga}} + \frac{{w}_{b}}{{T}_{gb}} + … + \frac{{w}_{i}}{{T}_{gi}}$$

The term ‘% by weight’ or ‘wt. %’ as used in the presently claimed invention is with respect to the total weight of the composition. Further, the sum of wt.-% of all the compounds, as described hereinbelow, in the respective component adds up to 100 wt.-%.

For the purposes of the presently claimed invention, the mass-average (Mw) and number-average (Mn) molecular weight is determined by means of gel permeation chromatography at 40° C., using a high-performance liquid chromatography pump and a refractive index detector. The eluent used was tetrahydrofuran with an elution rate of 1 ml/min. The calibration is carried out by means of polystyrene standards.

The above-mentioned measurement techniques are well known to a person skilled in the art and therefore do not limit the presently claimed invention.

The term “substituted” refers to an organic group as defined below (e.g., an alkyl group) in which one or more bonds to a hydrogen atom contained therein are replaced by a bond to nonhydrogen or non-carbon atoms. Substituted groups also include groups in which one or more bonds to carbon or hydrogen atom(s) are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; ethers; urethanes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, tert-butyl, neopentyl, and isopentyl groups. Representative substituted alkyl groups may be substituted one or more times with, for example, amino, thio, hydroxy, cyano, alkoxy, and/or halo groups such as F, Cl, Br, and I group. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

As used herein, “aryl,” or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. An aryl group with one or more alkyl groups may also be referred to as alkaryl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

For purposes of the presently claimed invention, the term acrylate or (meth)acrylate refers to acrylic or methacrylic acid, esters of acrylic or methacrylic acid, and salts, amides, and other suitable derivatives of acrylic or methacrylic acid, and mixtures thereof. Illustrative examples of suitable (meth)acrylic monomers include, without limitation, the following meth-acrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, iso-amyl methacrylate, 2-hydroxyethyl methacrylate, 2-hydroxypropyl methacrylate, N,N-dimethylaminoethyl methacrylate, N,N-diethylamino-ethyl methacrylate, t-butylaminoethyl methacrylate, 2-sul-foethyl methacrylate, trifluoroethyl methacrylate, glycidyl methacrylate (GMA), benzyl methacrylate, allyl methacrylate, 2-n-butoxyethyl methacrylate, 2-chloroethyl methacry-late, sec-butyl-methacrylate, tert-butyl methacrylate, 2-ethylbutyl methacrylate, cinnamyl methacrylate, crotyl methacrylate, cyclohexyl methacrylate, cyclopentyl meth-acrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, iso-amyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexaflu-oroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxy-ethyl acrylate, 2-phenylethyl acrylate, phenyl acrylate, propargyl acrylate, tetrahydrofurfuryl acrylate and tetrahydropyranyl acrylate.

For purposes of the presently claimed invention, the term styrene refers to styrene or alphamethylstyrene.

An aspect of the presently claimed invention relates to a process for preparing a polymer emulsion comprising at least the steps of:
i) providing a resin dispersion comprising at least one resin in water;
ii) adding at least one polymer seed and a polymerization mixture to the resin dispersion, the polymerization mixture comprising at least one co-polymerizable monomer; and
iii) preparing a polymer emulsion in water by radical emulsion polymerization of the polymerization mixture, the resin dispersion and the polymer seed;
   wherein the polymer emulsion has a solids content of at least 55 wt. %, based on the total weight of the polymer emulsion.

In an embodiment of the presently claimed invention, the polymer emulsion further includes the step of adding at least one surfactant to the resin dispersion in an amount in the range of ≤0.10 wt. %, based on the total weight of the polymer emulsion. In other exemplary embodiments, the at least one surfactant is added in an amount in the range of ≤0.09 wt. %, or ≤0.08 wt. %, or ≤0.07 wt. %, or ≤0.06 wt. %, or ≤0.05 wt. %, or ≤0.04 wt. %, or ≤0.03 wt. %, or ≤0.02 wt. %, or ≤0.01 wt. %, or ≤0.001 wt. %, in each case based on the total weight of the polymer emulsion.

Suitable surfactants include nonionic surfactants and anionic surfactants. Examples of nonionic surfactants include, but are not limited to, 5 to 70 moles of ethylene oxide adducted to straight chain and branched chain alkanols with 6 to 22 carbon atoms, or the corresponding C6-C22 alkylphenols, or fatty acids, or higher fatty amides, or primary and secondary higher alkyl amines; block copolymers of propylene oxide with ethylene oxide and mixtures thereof.

Representative examples of anionic surfactants include, but are not limited to, anionic compounds obtained by sulfonation of fatty derivatives such as sulfonated tallow, sulfonated vegetable oils and sulfonated marine animal oils. Commercially available emulsifiers of this group are Tallosan RC, a sulfonated tallow marketed by General Dyestuff Corp; Acidolate, a sulfonated oil marketed by White Laboratories, Inc.; and Chemoil 412, a sulfonated castor oil marketed by Standard Chemical Co. Also useful are various sulfonated and sulfated fatty acid esters of monoand polyvalent alcohols are also suitable such as Nopco 2272R, a sulfated butyl ester of fatty ester marketed by Nopco Chemical Company; Nopco 1471, a sulfated vegetable oil marketed by Nopco Chemical Company; Sandozol N, a sulfated fatty ester marketed by Sandoz, Inc.; and Stantex 322, an ester sulfate marketed by Standard Chemical Products, Inc. Sulfated and sulfonated fatty alcohols are also useful as an emulsifier and include anionic agents, such as Duponal ME, a sodium lauryl sulfate, Duponal L142, a sodium cetyl sulfate, Duponal LS, a sodium oleyl sulfate which is marketed by E.I. dePont de Nemours and Co.; and Tergitol 4, a sodium sulfate derivative of 7-ethyl-2-methyl, 4-undecanol, Tergitol 7, a sodium sulfate derivative of 3,9-diethyl tridecanol-6 and Tergitol 08, a sodium sulfate derivative of 2-ethyle-1-hexanol, which are marketed by Union Carbide Corp., Chemical Division. Preferred anionic surfactants are the alkyl esters of the alkali metal salts of sulfosuccunic acid.

In an embodiment of the presently claimed invention, the polymer emulsion in the step (iii) of the process disclosed herein is surfactant-free. “Surfactant-free” in the sense of the presently claimed invention means that the polymer emulsion may contain at least one surfactant in an amount in the range of ≤0.10 wt. %, based on the total weight of the polymer emulsion.

In an embodiment of the presently claimed invention, the process for preparing a polymer emulsion comprises at least the step of providing a resin dispersion comprising at least one resin in water. In an embodiment of the presently claimed invention, the at least one resin is selected from the group of polyacrylates, polymethacrylates and polystyrenes.

In another embodiment of the presently claimed invention, the at least one resin is derived from monomers selected from the group of acrylates, styrene and methacrylates and mixtures thereof.

Exemplary acrylate and methacrylate monomers include, but are not limited to, methyl acrylate, methyl methacrylate, ethyl acrylate, ethyl methacrylate, n-butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, and combinations thereof. Other suitable monomers include acrylic acid, acrylic acid esters and mixtures thereof.

For the purposes of the presently claimed invention, the polymers used as the basis for the diluted resin dispersion can be made by a continuous free radical polymerization process at relatively high temperatures. Here, the polymerization takes place in a homogenous environment. High reaction temperatures allow achieving low molecular weights of the resins without the use of chain transfer agents. After the polymerization step, the resin is subjected to a devolatilizer to remove unreacted monomers and process solvents. These polymers were prepared via a high temperature, continuous polymerization process as described in U.S. Pat. Nos. 5,461,60; 4,414,370; and 4,529,787, all of which are incorporated herein by reference.

In an embodiment of the presently claimed invention, the at least one resin is present in an amount in the range of from 5 wt. % to 40 wt. %, based on the total weight of the resin dispersion. In some embodiments, the at least one resin is present in an amount in the range of ≥10 wt. %, or ≥15 wt. %, or ≥20 wt. %, or ≥25 wt. %, or ≥30 wt. %, or ≥35 wt. %, in each case based on the total weight of the resin dispersion. In some embodiments, the at least one resin is present in an amount in the range of ≤35 wt. %, or ≤30 wt. %, or ≤25 wt. %, or ≤20 wt. %, or ≤15 wt. %, or ≤10 wt. %, in each case based on the total weight of the resin dispersion. The amount of resin based on the total weight of the resin dispersion can range from any of the minimum values described above to any of the maximum values described above.

In an embodiment of the presently claimed invention, the process for preparing a polymer emulsion comprises at least the step of providing at least one polymer seed and a polymerization mixture comprising at least one co-polymerizable monomer to the resin dispersion. In an embodiment of the presently claimed invention, the at least one polymer seed is selected from the group of polystyrene, poly(meth)acrylate, vinyl acetate polymer, ethylene vinyl acetate polymer, acrylic polymer, vinyl acrylic polymer and styrene (meth)acrylic polymer. In some embodiments, the at least one polymer seed is selected from the group of polystyrene, styrene (meth)acrylic polymer and poly(meth)acrylate.

In an embodiment of the presently claimed invention, the at least one polymer seed is polystyrene.

In an embodiment of the presently claimed invention, the at least one polymer seed comprises ≤1.0 wt. % of at least one acid monomer, based on the total weight of the at least one polymer seed. In other exemplary embodiments, the polymer seed comprises at least one acid monomer in an amount in the range of ≤0.9 wt. %, or ≤0.8 wt. %, or ≤0.7 wt. %, or ≤0.6 wt. %, or ≤0.5 wt. %, or ≤0.4 wt. %, or ≤0.3 wt. %, or ≤0.2 wt. %, or ≤0.1 wt. %, or ≤0.01 wt. %, in each case based on the total weight of the polymer seed.

In an embodiment of the presently claimed invention, the at least one acid monomer is selected from the group of ethylenically unsaturated carboxylic acids, ethylenically unsaturated sulfonic acids and vinylphosphonic acids.

In some embodiments, the at least one acid monomer is selected from the group of α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, vinyllactic acid, mesaconic acid, methylenemalonic acid, citraconic acid, and combinations thereof. Examples of suitable ethylenically unsaturated sulfonic acids include, but are not limited to, vinyl-sulfonic acids, styrenesulfonic acids, acrylamidoomethylpropanesulfonic acid, sulfopropyl acrylate, sulfopropyl methacrylate, and combinations thereof. The acid groups may be neutralized partly or completely with suitable bases such as aqueous sodium or potassium hydroxide solution or ammonia as a neutralizing agent.

In an embodiment of the presently claimed invention, the at least one polymer seed has a number average particle size diameter in the range of from 10 nm to 50 nm, determined according to dynamic light scattering method. In some embodiments, the at least one polymer seed has a number average particle size diameter in the range of from ≥10 nm, for example, ≥15 nm, or ≥20 nm, or ≥25 nm, or ≥30 nm, or ≥35 nm, or ≥40 nm, or ≥45 nm, in each case determined according to dynamic light scattering method. In some embodiments, the at least one polymer seed has a number average particle size diameter in the range of ≤50 nm, for example, ≤45 nm, or ≤40 nm, or ≤35 nm, or ≤30 nm, or ≤25 nm, or ≤20 nm, or ≤15 nm, in each case determined according to dynamic light scattering method. The number average particle size diameter of the at least one polymer see can range from any of the minimum values described above to any of the maximum values described above.

In an embodiment of the presently claimed invention, the at least one polymer seed has a weight average molecular weight in the range of from 10,000 g/mol to 500,000 g/mol, determined according to gel permeation chromatography. In some exemplary embodiments, the at least one polymer seed has a weight average molecular weight in the range of ≥20,000 g/mol, or ≥30,000 g/mol, or ≥40,000 g/mol, or ≥50,000 g/mol, or ≥60,000 g/mol, or ≥70,000 g/mol, or ≥80,000 g/mol, or ≥90,000 g/mol, or ≥100,000 g/mol, or ≥150,000 g/mol, or ≥200,000 g/mol, or ≥250,000 g/mol, or ≥300,000 g/mol, or ≥400,000 g/mol, in each case determined according to gel permeation chromatography. In some exemplary embodiments, the at least one polymer seed has a weight average molecular weight in the range of ≤450,000 g/mol, or ≤400,000 g/mol, or ≤300,000 g/mol, or ≤200,000 g/mol, or ≤100,000 g/mol, or ≤80,000 g/mol, or ≤60,000 g/mol, or ≤40,000 g/mol, or ≤20,000 g/mol, in each case determined according to gel permeation chromatography. The weight average molecular weight of the at least one polymer seed can range from any of the minimum values described above to any of the maximum values described above.

In an embodiment of the presently claimed invention, the at least one polymer seed is present in an amount in the range of from 0.1 wt. % to 5.0 wt. %, based on the total weight of the polymer emulsion. In some exemplary embodiments, the at least one polymer seed is present in an amount in the range of ≥0.2 wt. %, or ≥0.3 wt. %, or ≥0.4 wt. %, or ≥0.5 wt. %, or ≥0.6 wt. %, or ≥0.7 wt. %, or ≥0.8 wt. %, or ≥0.9 wt. %, or ≥1.0 wt. %, or ≥1.5 wt. %, or ≥2.0 wt. %, or ≥2.5 wt. %, or ≥3.0 wt. %, or ≥3.5 wt. %, or ≥4.0 wt. %, in each case based on the total weight of the polymer emulsion. In some exemplary embodiments, the at least one polymer seed is present in an amount in the range of ≤4.5 wt. %, or ≤4.0 wt. %, or ≤3.5 wt. %, or ≤3.0 wt. %, or ≤2.5 wt. %, or ≤2.0 wt. %, or ≤1.0 wt. %, or ≤0.5 wt. %, in each case based on the total weight of the polymer emulsion. The amount of the polymer seed in the polymer emulsion can range from any of the minimum values described above to any of the maximum values described above.

In an embodiment of the presently claimed invention, the at least one polymer seed has a solids content in the range of from 1.0 wt. % to 50.0 wt. %, based on the total weight of the polymer seed. In some exemplary embodiments, the at least one polymer seed has a solids content in the range of ≥2.0 wt. %, or ≥3.0 wt. %, or ≥4.0 wt. %, or ≥5.0 wt. %, or ≥6.0 wt. %, or ≥7.0 wt. %, or ≥8.0 wt. %, or ≥9.0 wt. %, or ≥10.0 wt. %, or ≥15.0 wt. %, or ≥20.0 wt. %, or ≥25.0 wt. %, or ≥30.0 wt. %, or ≥35.0 wt. %, or ≥40.0 wt. %, in each case based on the total weight of the polymer seed. In some exemplary embodiments, the at least one polymer seed has a solids content in the range of ≤45.0 wt. %, or ≤40.0 wt. %, or ≤35.0 wt. %, or ≤30.0 wt. %, or ≤25.0 wt. %, or ≤20.0 wt. %, or ≤15.0 wt. %, or ≤10.0 wt. %, or ≤5.0 wt. %, or ≤4.0 wt. %, or ≤3.0 wt. %, or ≤2.0 wt. %, in each case based on the total weight of the polymer seed. The solids content in the at least one polymer seed based on the total weight of the polymer seed can range from any of the minimum values described above to any of the maximum values described above.

In an embodiment of the presently claimed invention, the at least one co-polymerizable monomer is selected from the group of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, styrene, α-methyl styrene, ethyl acrylate, n-propyl acrylate, iso-propyl acrylate, 1,4-butanediol diacrylate, n-butyl acrylate, n-butyl acrylate, iso-butyl acrylate, t-butyl acrylate, n-amyl acrylate, iso-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, hydroxyethyl acrylate, hydroxypropyl acrylate, hydroxybutyl acrylate, methyl methacrylate, ethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, glycidyl methacrylate, crotyl methacrylate, cyclohexyl methacrylate, cyclopentyl methacrylate, 2-ethoxyethyl methacrylate, isobornyl methacrylate, hydroxyethyl methacrylate, hydroxypropyl methacrylate, hydroxybutyl methacrylate, ureido methacrylate, acrylamide, methacrylamide, N-butoxymethyl methacrylamide, N-methylol acrylamide, N-methylol methacrylamide, diacetone acrylamide, vinyl acetate and acrylonitrile.

In some exemplary embodiments, the at least one co-polymerizable monomer is selected from the group of acrylates and methacrylates. Exemplary acrylate and methacrylate monomers include, but are not limited to, methyl acrylate, methyl methacrylate, ethyl acrylate, ethyl methacrylate, butyl acrylate, butyl methacrylate, 2-ethylhexyl acrylate, 2-ethylhexyl methacrylate, iso-butyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycolmono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, and combinations thereof.

In an embodiment of the presently claimed invention, the at least one co-polymerizable monomer has a theoretical weight average molecular weight in the range of from 50 g/mol to 500 g/mol. In some exemplary embodiments, the at least one co-polymerizable monomer has a theoretical weight average molecular weight in the range of ≥70 g/mol, or ≥90 g/mol, or ≥100 g/mol, or ≥120 g/mol, or ≥150 g/mol, or ≥175 g/mol, or ≥190 g/mol, or ≥200 g/mol, or ≥220 g/mol, or ≥250 g/mol, or ≥275 g/mol, or ≥300 g/mol, or ≥350 g/mol, or ≥400 g/mol, or ≥450 g/mol. In some exemplary embodiments, the at least one co-polymerizable monomer has a theoretical weight average molecular weight in the range of ≤450 g/mol, or ≤400 g/mol, or ≤350 g/mol, or ≤300 g/mol, or ≤250 g/mol, or ≤200 g/mol, or ≤100 g/mol, or ≤75 g/mol. The theoretical weight average molecular weight of the at least one co-polymerizable monomer can range from any of the minimum values described above to any of the maximum values described above.

In an embodiment of the presently claimed invention, the at least one co-polymerizable monomer is present in an amount in the range of from 15 wt. % to 65 wt. %, based on the total weight of the polymer emulsion. In some exemplary embodiments, the at least one co-polymerizable monomer is present in an amount in the range of ≥20 wt. %, or ≥25 wt. %, or ≥30 wt. %, or ≥35 wt. %, or ≥40 wt. %, or ≥45 wt. %, or ≥50 wt. %, or ≥55 wt. %, or ≥60 wt. %, in each case based on the total weight of the polymer emulsion. In some exemplary embodiments, the at least one co-polymerizable monomer is present in an amount in the range of ≤60 wt. %, or ≤55 wt. %, or ≤50 wt. %, or ≤45 wt. %, or ≤40 wt. %, or ≤35 wt. %, or ≤30 wt. %, or ≤25 wt. %, or ≤20 wt. %, in each case based on the total weight of the polymer emulsion. The amount of the at least one copolymerizable monomer can range from any of the minimum values described above to any of the maximum values described above.

In some exemplary embodiments, the at least one co-polymerizable monomer is derived from at least 80 wt. % of (meth)acrylate ester monomers. Suitable examples of (meth)acrylate ester monomers include, but are not limited to, C₁-C₂₀ alkyl (meth)acrylates, such as methyl acrylate, methyl methacrylate, ethyl acrylate, n-butyl acrylate, n-butyl methacrylate, n-hexyl acrylate, octyl acrylate, 2-ethylhexyl acrylate and 2-propylheptyl acrylate. Also suitable are mixtures of (meth) acrylic acid alkyl esters.

For the purposes of the presently claimed invention, the at least one co-polymerizable monomer can also be selected from group of acid monomers, vinyl esters of carboxylic acids, vinyl aromatics, ethylenically unsaturated nitriles, vinyl halides, vinyl ethers, aliphatic hydrocarbons and mixtures thereof.

In an embodiment of the presently claimed invention, the at least one co-polymerizable monomer used in the polymerization disclosed herein comprise less than 5 wt. % of acid groups, for example, less than 4 wt. %, or less than 3 wt. %, or less than 2 wt. %, or less than 1 wt. %, of the total weight of the monomers. In some embodiments, the at least one co-polymerizable monomer used in polymerization disclosed herein has no acid groups.

In an embodiment of the presently claimed invention, the at least one co-polymerizable monomer has a theoretical glass transition temperature, Tg in the range of from −60° C. to 10° C. In some exemplary embodiments, the at least one co-polymerizable monomer has a theoretical glass transition temperature, Tg in the range of ≥−50° C., or ≥−40° C., or ≥−30° C., or ≥−20° C., or ≥−10° C., or ≥0° C. In some exemplary embodiments, the at least one co-polymerizable monomer has a theoretical glass transition temperature, Tg, in the range of ≤5° C., or ≤0° C., or ≤−10° C., or ≤−20° C., or ≤−30° C., or ≤−40° C., or ≤−50° C. The theoretical glass transition temperature of the at least one co-polymerizable monomer can range from any of the minimum values described above to any of the maximum values described above.

In an embodiment of the presently claimed invention, the polymerization mixture further comprises at least one water-soluble initiator.

In an embodiment of the presently claimed invention, the at least one water-soluble initiator is selected from the group of ammonium or alkali metal salts of peroxodisulfuric acid, and peroxides.

In an embodiment of the presently claimed invention, the at least one water-soluble initiator is selected from the group of ammonium or alkali metal salts of peroxodisulfuric acid, such as sodium peroxodisulfate, hydrogen peroxide or organic peroxides, for example, tert-butyl hydroperoxide. Also suitable as initiators are those known as reduction-oxidation (redox) initiators. The redox initiator systems consist of at least one, usually inorganic, reducing agent and one organic or inorganic oxidizing agent. The oxidizing component comprises, for example, the initiators already stated above for the emulsion polymerization. The reducing component is, for example, alkali metal salts of sulfurous acid, such as, for example, sodium sulfite, sodium hydrogensulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems can be used along with soluble metal compounds whose metallic component is able to exist in a plurality of valence states. Customary redox initiator systems are, for example, ascorbic acid/iron(II) sulfate/sodium peroxodisulfate, tert-butyl hydroperoxide/sodium di sulfite, tert-butyl hydroperoxide/sodium hydroxymethanesulfinic acid. The individual components, the reducing component, for example, may also be mixtures, an example being a mixture of the sodium salt of hydroxymethanesulfinic acid with sodium disulfite.

In an embodiment of the presently claimed invention, the at least one water-soluble initiator is present in an amount in the range of from 0.10 wt. % to 5.0 wt. %, based on the total weight of the monomers in the polymerization mixture. In some exemplary embodiments, the at least one water-soluble initiator is present in an amount in the range of ≥0.20 wt. %, or ≥0.30 wt. %, or ≥0.40 wt. %, or ≥0.50 wt. %, or ≥0.60 wt. %, or ≥0.70 wt. %, or ≥0.80 wt. %, or ≥0.90 wt. %, or ≥1.0 wt. %, or ≥1.5 wt. %, or ≥2.0 wt. %, or ≥2.5 wt. %, or ≥3.0 wt. %, or ≥3.5 wt. %, or ≥4.0 wt. %, or ≥4.5 wt. %, in each case based on the total weight of the monomers in the polymerization mixture. In some exemplary embodiments, the at least one water-soluble initiator is present in an amount in the range of ≤4.5 wt. %, or ≤4.0 wt. %, or ≤3.5 wt. %, or ≤3.0 wt. %, or ≤2.5 wt. %, or ≤2.0 wt. %, or ≤1.5 wt. %, or ≤1.0 wt. %, or ≤0.50 wt. %, or ≤0.3 wt. %, in each case based on the total weight of the monomers in the polymerization mixture. The amount of the at least one water-soluble initiator can range from any of the minimum values described above to any of the maximum values described above.

In an embodiment of the presently claimed invention, the weight ratio of the at least one polymer seed to the at least one co-polymerizable monomer is in the range of from 0.2:100 to 5:100. In some exemplary embodiments of the presently claimed invention, the weight ratio of the at least one polymer seed to the at least one co-polymerizable monomer is in the range of from 0.2:100 to 0.4:100, or from 0.2:100 to 0.5:100, or from 0.2:100 to 1.0:100, or from 0.2:100 to 2.0:100, or from 0.2:100 to 3.0:100, or from 0.2:100 to 4.0:100. In some exemplary embodiments of the presently claimed invention, the weight ratio of the at least one polymer seed to the at least one co-polymerizable monomer is less than 4:100, less than 3:100, less than 2:100, less than 1:100, less than 0.5:100, less than 0.3:100. In some exemplary embodiments of the presently claimed invention, the weight ratio of the at least one polymer seed to the at least one co-polymerizable monomer is at least 0.3:100, at least 0.5:100, at least 1.0:100, at least 1.5:100, at least 2.0:100, at least 2.5:100, at least 3.0:100, at least 3.5:100, at least 4.0:100, at least 4.5:100. The weight ratio of the at least one polymer seed to the at least one co-polymerizable monomer can range from any of the minimum ratios described above to any of the maximum ratios described above.

In an embodiment of the presently claimed invention, the weight ratio of the at least one resin to the at least one co-polymerizable monomer is in the range of from 5:100 to 40:100. In some exemplary embodiments, the weight ratio of the at least one resin to the at least one copolymerizable monomer is in the range of 10:100 to 40:100, or 15:100 to 20:100, or 5:100 to 40:100, or 5:100 to 35:100, or 5:100 to 30:100, or 5:100 to 20:100. In some exemplary embodiments of the presently claimed invention, the weight ratio of the at least one resin to the at least one co-polymerizable monomer is less than 35:100, less than 30:100, less than 25:100, less than 20:100, less than 15:100, less than 10:100. In some exemplary embodiments of the presently claimed invention, the weight ratio of the at least one resin to the at least one co-polymerizable monomer is at least at least 10:100, at least 15:100, at least 20:100, at least 25:100, at least 30:100, or at least 35:100. The weight ratio of the at least one resin to the at least one copolymerizable monomer can range from any of the minimum ratios described above to any of the maximum ratios described above.

In an embodiment of the presently claimed invention, the polymer emulsion has a solids content of at least 60 wt. %, based on the total weight of the polymer emulsion. In some exemplary embodiments, the polymer emulsion has a solids content of at least 65 wt. %, at least 70 wt. %, at least 75 wt. %, at least 80 wt. %, or at least 85 wt. %.

In an embodiment of the presently claimed invention, the polymer emulsion has a glass transition temperature Tg in the range of from −60° C. to 120° C., determined according to dynamic scanning calorimetry. In some embodiments, the polymer emulsion has a glass transition temperature Tg in the range of from ≥−50° C., or ≥−40° C., or ≥−30° C., or ≥−20° C., or ≥−10° C., or ≥0° C., or ≥5° C., or ≥10° C., or ≥20° C., or ≥30° C., or ≥40° C., or ≥50° C., or ≥60° C., or ≥70° C., or ≥80° C., or ≥90° C., or ≥100° C., in each case determined according to dynamic scanning calorimetry. In some exemplary embodiments, the polymer emulsion has a glass transition temperature in the range of ≤110° C., or ≤100° C., or ≤90° C., or ≤80° C., or ≤70° C., or ≤60° C., or ≤50° C., or ≤40° C., or ≤30° C., or ≤20° C., or ≤10° C., or ≤0° C., or ≤−10° C., or ≤−20° C., or ≤−30° C., or ≤−40° C., or ≤−50° C., in each case determined according to dynamic scanning calorimetry. The glass transition temperature of the polymer emulsion can range from any of the minimum values described above to any of the maximum values described above.

In an embodiment of the presently claimed invention, the polymer emulsion has a viscosity in the range of from 50 cps to 10,000 cps, measured using a viscometer with a #63 spindle, 60 RPM at 25° C. In some exemplary embodiments, the polymer emulsion has a viscosity in the range of ≥100 cps, or ≥200 cps, or ≥300 cps, or ≥400 cps, or ≥500 cps, or ≥600 cps, or ≥700 cps, or ≥800 cps, or ≥900 cps, or ≥1000 cps, or ≥1500 cps, or ≥2000 cps, or ≥3000 cps, or ≥4000 cps, or ≥5000 cps, or ≥6000 cps, or ≥7000 cps, or ≥8000 cps, or ≥9000 cps, in each case measured using a viscometer with a #63 spindle, 60 RPM at 25° C. In some exemplary embodiments, the polymer emulsion has a viscosity in the range of ≤9,000 cps, or ≤8,000 cps, or ≤7,000 cps, or ≤6,000 cps, or ≤5,000 cps, or ≤4,000 cps, or ≤3,000 cps, or ≤2,000 cps, or ≤1,000 cps, or ≤500 cps, or ≤200 cps, in each case measured using a viscometer with a #63 spindle, 60 RPM at 25° C. The viscosity of the polymer emulsion can range from any of the minimum values described above to any of the maximum values described above.

In an embodiment of the presently claimed invention, the polymer emulsion contains particles that have a volume average particle size diameter in the range of from 100 nm to 1000 nm, determined according to dynamic light scattering method. In some exemplary embodiments, the polymer emulsion contains particles that have a volume average particle size diameter in the range of ≥150 nm, or ≥200 nm, or ≥250 nm, or ≥300 nm, or ≥350 nm, or ≥400 nm, or ≥450 nm, or ≥500 nm, or ≥550 nm, or ≥600 nm, or ≥650 nm, or ≥700 nm, or ≥750 nm, or ≥800 nm, or ≥850 nm, or ≥900 nm, or ≥950 nm, in each case determined according to dynamic light scattering method. In some exemplary embodiments, the polymer emulsion contains particles that have a volume average particle size diameter in the range of ≤950 nm, or ≤900 nm, or ≤800 nm, or ≤850 nm, or ≤800 nm, or ≤750 nm, or ≤700 nm, or ≤650 nm, or ≤600 nm, or ≤550 nm, or ≤500 nm, or ≤450 nm, or ≤400 nm, or ≤350 nm, or ≤300 nm, or ≤250 nm, or ≤200 nm, or ≤150 nm, in each case determined according to dynamic light scattering method. The volume average particle size diameter of the particles in the polymer emulsion can range from any of the minimum values described above to any of the maximum values described above.

In an embodiment of the presently claimed invention, the process for preparing a polymer emulsion comprises at least the step of preparing a polymer emulsion in water by radical emulsion polymerization of the polymerization mixture, the resin dispersion and the polymer seed. In an embodiment of the presently claimed invention, the radical emulsion polymerization is a semi-batch process.

In an embodiment of the presently claimed invention, the particle size distribution of the particles in the polymer emulsion is bimodal or multimodal. The average particle size distribution of the particles dispersed in the polymer emulsion in case of bimodal and multi-modal distribution may be up to 1000 nm. The average particle size refers to d₅₀ of the particle size distribution, i.e. 50 wt. % of the total weight of all the particles have a small particle diameter than the d₅₀. The particle size distribution can be determined using the analytical ultracentrifuge.

The process of preparation of the polymer emulsion includes polymerization of the reaction mixture of components described in step (iii) as disclosed herein. The polymerization is generally performed by a free-radical emulsion polymerization process. The emulsion polymerization can be carried out by changing the monomer feed rate. The emulsion polymerization can be carried out under surfactant-free conditions. The emulsion polymerization temperature can range from 10° C. to 130° C., for e.g., from 50° C. to 100° C. The temperature may be raised during the polymerization, for example from a starting temperature in the range of from 50° C. to 85° C. to a final temperature in the range of from 85° C. to 100° C. The polymerization medium can include water alone or a mixture of water and water-miscible liquids, such as methanol, ethanol or tetrahydrofuran. In some embodiments, the polymerization medium is free of organic solvents and includes only water.

The emulsion polymerization can be carried out as a batch process or as a semi-batch process. In some embodiments, a portion of the monomers can be heated to the polymerization temperature and partially polymerized, and the remainder of the monomer batch can be subsequently fed to the polymerization zone continuously, in steps, or with superposition of a concentration gradient.

In some embodiments, the process of preparing the polymer emulsion comprises polymerizing at least one ethylenically unsaturated monomer, in a first emulsion polymerization step to produce a first polymer having a first theoretical Tg; and polymerizing one or more ethylenically unsaturated monomers in a second emulsion polymerization step to produce a second polymer having a second theoretical Tg, wherein the one or more ethylenically unsaturated monomers comprise at least 50% by weight of the monomers polymerized to form the second polymer particle. In some embodiments, the first polymerization step and/or the second polymerization step are carried out at a first polymerization temperature in the range of from 10° C. to 130° C. (e.g., from 50° C. to 100° C., or from 70° C. to 90° C.). In one embodiment, the first polymerization step and the second polymerization step are carried out at polymerization temperatures of less than or equal to 85° C.

The emulsion polymerization can be performed with a variety of auxiliaries, including water-soluble initiators and regulators. Examples of water-soluble initiators for the emulsion polymerization are ammonium salts and alkali metal salts of peroxodisulfuric acid, e.g., sodium peroxodisulfate, hydrogen peroxide or organic peroxides, e.g., tert-butyl hydroperoxide. Reduction oxidation (redox) initiator systems are also suitable as initiators for the emulsion polymerization. The redox initiator systems are composed of at least one, usually inorganic, reducing agent and one organic or inorganic oxidizing agent. The oxidizing component comprises, for example, the initiators already specified above for the emulsion polymerization. The reducing components are, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxy methanesulfinic acid and salts thereof, or ascorbic acid. The redox initiator systems can be used in the company of soluble metal compounds whose metallic component is able to exist in a plurality of valence states. Typical redox initiator systems include, for example, ascorbic acid/iron(II) sulfate/sodium peroxodisulfate, tert-butyl hydroperoxide/sodium disulfite, tert-butyl hydroperoxide/Na hydroxymethanesulfinate, or tert-butyl hydroperoxide/ascorbic acid. The individual components, the reducing component for example, can also be present in the form of mixtures, an example being a mixture of the sodium salt of hydroxymethanesulfinic acid with sodium disulfite. The stated compounds are used usually present in the form of aqueous solutions, with the lower concentration being determined by the amount of water that is acceptable in the dispersion, and the upper concentration by the solubility of the respective compound in water. The concentration can be 0.1% to 30%, 0.5% to 20%, or 1.0% to 10%, by weight, based on the solution. The amount of the initiators is generally 0.1% to 10% or 0.5% to 5% by weight, based on the monomers to be polymerized. It is also possible for two or more different initiators to be used in the emulsion polymerization. For the removal of the residual monomers, an initiator can be added after the end of the emulsion polymerization.

In the polymerization it is possible to use molecular weight regulators or chain transfer agents, in amounts, for example, of 0 to 0.8 parts by weight, based on 100 parts by weight of the monomers to be polymerized, to reduce the molecular weight of the copolymer. Suitable examples include compounds having a thiol group such as tert-butyl mercaptan, thioglycolic acid ethylacrylic esters, mercaptoethanol, mercaptopropyltrimethoxysilane, and tert-dodecyl mercaptan. Additionally, it is possible to use regulators without a thiol group, such as terpinolene. In some embodiments, the emulsion polymer is prepared in the presence of greater than 0% to 0.5% by weight, based on the monomer amount, of at least one molecular weight regulator. In some embodiments, the emulsion polymer is prepared in the presence of less than less than 0.3% or less than 0.2% by weight (e.g., 0.10% to 0.15% by weight) of the molecular weight regulator.

Another aspect of the presently claimed invention is directed to a polymer emulsion obtainable by the process disclosed herein. In an embodiment of the presently claimed invention, the particle size distribution of the polymer emulsion is bimodal or multimodal. The average particle size distribution of the particles dispersed in the polymer emulsion in case of bimodal and multi-modal distribution may be up to 1000 nm. The average particle size refers to d₅₀ of the particle size distribution, i.e. 50 wt. % of the total weight of all the particles have a small particle diameter than the d₅₀. The particle size distribution can be determined using the analytical ultracentrifuge.

In another embodiment of the presently claimed invention, the polymer emulsion contains at least one surfactant in an amount in the range of ≤0.10 wt. %, based on the total weight of the polymer emulsion.

Suitable surfactants include nonionic surfactants and anionic surfactants. Examples of nonionic surfactants include, but are not limited, to 5 to 70 moles of ethylene oxide adducted to straight chain and branched chain alkanols with 6 to 22 carbon atoms, or the corresponding C6-C22 alkylphenols, or fatty acids, or higher fatty amides, or primary and secondary higher alkyl amines; block copolymers of propylene oxide with ethylene oxide and mixtures thereof.

Representative examples of anionic surfactants include, but are not limited to, anionic compounds obtained by sulfonation of fatty derivatives such as sulfonated tallow, sulfonated vegetable oils and sulfonated marine animal oils. Commercially available emulsifiers of this group are Tallosan RC, a sulfonated tallow marketed by General Dyestuff Corp; Acidolate, a sulfonated oil marketed by White Laboratories, Inc.; and Chemoil 412, a sulfonated castor oil marketed by Standard Chemical Co. Also useful are various sulfonated and sulfated fatty acid esters of monoand polyvalent alcohols are also suitable such as Nopco 2272R, a sulfated butyl ester of fatty ester marketed by Nopco Chemical Company; Nopco 1471, a sulfated vegetable oil marketed by Nopco Chemical Company; Sandozol N, a sulfated fatty ester marketed by Sandoz, Inc.; and Stantex 322, an ester sulfate marketed by Standard Chemical Products, Inc. Sulfated and sulfonated fatty alcohols are also useful as an emulsifier and include anionic agents, such as Duponal ME, a sodium lauryl sulfate, Duponal L142, a sodium cetyl sulfate, Duponal LS, a sodium oleyl sulfate which is marketed by E.I. dePont de Nemours and Co.; and Tergitol 4, a sodium sulfate derivative of 7-ethyl-2-methyl, 4-undecanol, Tergitol 7, a sodium sulfate derivative of 3,9-diethyl tridecanol-6 and Tergitol 08, a sodium sulfate derivative of 2-ethyle-1-hexanol, which are marketed by Union Carbide Corp., Chemical Division. Preferred anionic surfactants are the alkyl esters of the alkali metal salts of sulfosuccunic acid.

In an embodiment of the presently claimed invention, the polymer emulsion is surfactant-free.

In a yet another embodiment of the presently claimed invention, the polymer emulsion is suitable for the preparation of adhesives, labels, composite films, protective film lamination, coatings, sound damping, primers, inks and pigment dispersions. In one embodiment of the presently claimed invention, the polymer emulsion is used for producing adhesives. In another embodiment of the presently claimed invention, the polymer emulsion is used for producing pressuresensitive adhesives or laminating adhesives.

In another embodiment of the presently claimed invention, the polymer emulsion can further comprise a dispersant, an adhesion enhancer, a light stabilizer, a film forming aid, a defoamer, a thickener, a wetting agent, a biocide, a tackifier, or a combination thereof.

Examples of suitable dispersants include, but are not limited to, polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers.

Examples of suitable thickening agents include but are not limited to hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide).

Suitable defoamers include, but are not limited to, silicone oil defoamers, such as polysiloxanes, polydimethylsiloxanes, polyether modified polysiloxanes, and combinations thereof. Exemplary silicone-based defoamers include BYK®-035, available from BYK USA Inc. (Wallingford, Conn.), the TEGO® series of defoamers, available from Evonik Industries (Hopewell, Va.), and the DREWPLUS® series of defoamers, available from Ashland Inc. (Covington, Ky.).

Exemplary biocides include, but are not limited, to 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyl and-4-isothiazolin-3-one (CIT), 2-octyl-4-isothiazolin-3-one (OIT), 4,5-dichloro-2-n-octyl-3-isothiazolone, as well as acceptable salts and combinations thereof. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl-4-isothiazolin-3-one, diiodomethyl p-tolyl sulfone, as well as acceptable salts and combinations thereof.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### EMBODIMENTS

In the following, there is provided a list of embodiments to further illustrate the present disclosure without intending to limit the disclosure to the specific embodiments listed below.

Embodiment 1: A process for preparing a polymer emulsion comprising the steps of:
i) providing a resin dispersion comprising at least one resin in water;
ii) adding at least one polymer seed and a polymerization mixture to the resin dispersion, said polymerization mixture comprising at least one co-polymerizable monomer; and
iii) preparing a polymer emulsion in water by radical emulsion polymerization of the polymerization mixture, the resin dispersion and the polymer seed;
   wherein the polymer emulsion has a solids content of at least 55 wt. %, based on the total weight of the polymer emulsion.

Embodiment 2: The process according to embodiment 1, wherein the polymer emulsion further includes at least one surfactant in an amount in the range of ≤0.10 wt. %, based on the total weight of the polymer emulsion.

Embodiment 3: The process according to embodiment 1 or 2, wherein the at least one resin is selected from the group of polyacrylates, polymethacrylates and polystyrenes.

Embodiment 4: The process according to any of the embodiments 1 to 3, wherein the at least one resin is present in an amount in the range of from 5 wt. % to 40 wt. %, based on the total weight of the resin dispersion.

Embodiment 5: The process according to embodiment 1, wherein the at least one polymer seed is selected from the group of polystyrene, poly(meth)acrylate, vinyl acetate polymer, ethylene vinyl acetate polymer, acrylic polymer, vinyl acrylic polymer and styrene (meth)acrylic polymer.

Embodiment 6: The process according to embodiment 1, wherein the at least one polymer seed comprises ≤1.0 wt. % of at least one acid monomer, based on the total weight of the at least one polymer seed.

Embodiment 7: The process according to embodiment 6, wherein the at least one acid monomer is selected from the group of ethylenically unsaturated carboxylic acids, ethylenically unsaturated sulfonic acids and vinylphosphonic acids.

Embodiment 8: The process according to any of the embodiments 1 to 7, wherein the at least one polymer seed has a number average particle size diameter in the range of from 10 nm to 50 nm, determined according to dynamic light scattering method.

Embodiment 9: The process according to any of the embodiments 1 to 8, wherein the at least one polymer seed has a weight average molecular weight in the range of from 10,000 g/mol to 500,000 g/mol, determined according to gel permeation chromatography.

Embodiment 10: The process according to any of the embodiments 1 to 9, wherein the at least one polymer seed is present in an amount in the range of from 0.1 wt. % to 5.0 wt. %, based on the total weight of the polymer emulsion.

Embodiment 11: The process according to any of the embodiments 1 to 10, wherein the at least one polymer seed has a solids content in the range of from 1.0 wt. % to 50.0 wt. %, based on the total weight of the polymer seed.

Embodiment 12: The process according to any of the embodiments 1 to 11, wherein the at least one co-polymerizable monomer is selected from the group of acrylic acid, methacrylic acid, itaconic acid, maleic acid, fumaric acid, crotonic acid, vinylacetic acid, vinyllactic acid, vinyl-sulfonic acid, styrenesulfonic acid, acrylamidomethylpropanesulfonic acid, sulfopropyl acrylate, sulfopropyl methacrylate, styrene, α-methyl styrene, ethyl acrylate, n-propyl acrylate, iso-propyl acrylate, 1,4-butanediol diacrylate, n-butyl acrylate, n-butyl acrylate, iso-butyl acrylate, t-butyl acrylate, n-amyl acrylate, iso-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, hydroxyethyl acrylate, hydroxypropyl acrylate, hydroxybutyl acrylate, methyl methacrylate, ethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, glycidyl methacrylate, crotyl methacrylate, cyclohexyl methacrylate, cyclopentyl methacrylate, 2-ethoxyethyl methacrylate, isobornyl methacrylate, hydroxyethyl methacrylate, hydroxypropyl methacrylate, hydroxybutyl methacrylate, ureido methacrylate, acrylamide, methacrylamide, N-butoxymethyl methacrylamide, N-methylol acrylamide, N-methylol methacrylamide, diacetone acrylamide, vinyl acetate and acrylonitrile.

Embodiment 13: The process according to any of the embodiments 1 to 12, wherein the at least one co-polymerizable monomer has a theoretical weight average molecular weight in the range of from 50 g/mol to 500 g/mol.

Embodiment 14: The process according to embodiment 12 or 13, wherein the at least one copolymerizable monomer is present in an amount in the range of from 15 wt. % to 65 wt. %, based on the total weight of the polymer emulsion.

Embodiment 15: The process according to any of the embodiments 1 to 14, wherein the polymerization mixture further comprises at least one water-soluble initiator.

Embodiment 16: The process according to embodiment 15, wherein the at least one water-soluble initiator is selected from the group of ammonium or alkali metal salts of peroxodisulfuric acid, and peroxides.

Embodiment 17: The process according to embodiment 15 or 16, wherein the at least one water-soluble initiator is present in an amount in the range of from 0.10 wt. % to 5.0 wt. %, based on the total weight of the monomers in the polymerization mixture.

Embodiment 18: The process according to embodiment 1, wherein the weight ratio of the at least one polymer seed to the at least one co-polymerizable monomer is in the range of from 0.2:100 to 5:100.

Embodiment 19: The process according to embodiment 1, wherein the weight ratio of the at least one resin to the at least one co-polymerizable monomer is in the range of from 5:100 to 40:100.

Embodiment 20: The process according to any of the embodiments 1 to 19, wherein the polymer emulsion has a solids content of at least 60 wt. % based on the total weight of the polymer emulsion.

Embodiment 21: The process according to any of the embodiments 1 to 20, wherein the polymer emulsion has a glass transition temperature in the range of from −60° C. to 120° C., determined according to dynamic scanning calorimetry.

Embodiment 22: The process according to any of the embodiments 1 to 21, wherein the polymer emulsion has a viscosity in the range of from 50 cps to 10,000 cps, measured using a viscometer with a #63 spindle, 60 RPM at 25° C.

Embodiment 23: The process according to any of the embodiments 1 to 22, wherein the polymer emulsion contains particles that have a volume average particle size diameter in the range of from 100 nm to 1000 nm, determined according to dynamic light scattering method.

Embodiment 24: The process according to any of the embodiments 1 to 23, wherein the step of preparing a polymer emulsion in water by radical emulsion polymerization is a semi-batch process.

Embodiment 25: A polymer emulsion obtainable by the process according to any of the embodiments 1 to 25.

Embodiment 26: The polymer emulsion according to embodiment 25, which comprises particles that are present in a bimodal or a multimodal particle size distribution.

Embodiment 27: The polymer emulsion according to embodiments 25 or 26, wherein the polymer emulsion contains at least one surfactant in an amount in the range of 0.10 wt. %, based on the total weight of the polymer emulsion.

Embodiment 28: The polymer emulsion according to any of the embodiments 25 to 27, wherein the polymer emulsion is suitable in preparation of adhesives, composite films, protective film lamination, coatings, sound damping, primers, inks or pigment dispersions.

While the presently claimed invention has been described in terms of its specific embodiments, certain modifications and equivalents will be apparent to those skilled in the art and are intended to be included within the scope of the presently claimed invention.

The presently claimed invention is associated with at least one of the following advantages:
(i) The presently claimed invention provides polymer emulsion with high solids content of at least 55 wt. %.
(ii) The process of preparing the polymer emulsion disclosed herein eliminates the need of surfactant to stabilize the polymer emulsion.
(iii) The process of preparing the polymer emulsion according to the presently claimed invention enables improved application properties compared to surfactant-based polymer emulsions.
(iv) The process of preparing the polymer emulsion according to the presently claimed invention provides stabilized polymer emulsions with low viscosity.
(v) The process of preparing the polymer emulsion according to the presently claimed invention provides desirable particle size distributions of the particles in the polymer emulsion.
(vi) The polymer emulsion prepared according to the process disclosed herein can be used in coatings, sound dampening, primers, inks, pigment dispersions, pressure sensitive adhesives, or any other application that needs a high solids content.

### EXAMPLES

Aspects of the presently claimed invention are more fully illustrated by the following examples, which are set forth to illustrate certain aspects of the present invention and are not to be construed as limiting thereof.

Components:
The resin stabilizers used in the Examples 1-6 and Comparative Examples 1-2 were prepared by continuous free radical polymerization process disclosed in the detailed description.
The polymer seed used in Examples 1-6: polystyrene was obtained from BASF SE
The monomers in the feeds and other components such as initiator, reducers and post addition components in Tables 1-8 were obtained from Sigma Aldrich.

Example 1: The process for preparing polymer emulsion began by preparing an initial pot charge of diluted resin dispersion (Table 1), which was then agitated while heating to the reaction temperature of 88° C. Once the pot charge had reached a temperature of 80° C., tert-butyl hydroperoxide was charged to the reactor, and the mixture was held for one minute. Persulfate initiator solution (44 vol. % of total) and the polymer seed (Table 1) were then charged to the reactor. After holding for 15 minutes, monomer feeds 1 and 2 (Table 1) were started; all of feed 1 and half of feed 2 (Table 1) were charged to the reactor over 50 minutes. After 50 minutes, monomer feed 2 (Table 1) was paused for 10 minutes. A shot of persulfate initiator solution (28 vol. % of total) was then charged to the reactor, monomer feed 2 (Table 1) was resumed, and monomer feed 3 (Table 1) was started. The remainder of monomer feed 2 (Table 1) and all of monomer feed 3 (Table 1) were charged to the reactor over 50 minutes. After the completion of monomer feeds 2 and 3 (Table 1), a final shot of persulfate initiator solution (28 vol. % of total) was charged to the reactor and the reaction was held at temperature for 90 minutes. The reducer (sodium erythrobate) solution was then fed over 10 minutes, the reactor was cooled to room temperature, and the post-adds (Table 1) were charged to the reactor. The final emulsion was poured into collection containers through a 150 μm mesh to filter and measure the presence of large impurities/grit.

TABLE 1
Polymer Emulsion of Example 1

| Component | Composition | pphm* |
|---|---|---|
| Pot charge | deionized-water/ | 0.0/10.0/0.12 |
| | 30 wt. % of resin dispersion | |
| | (n-butyl acrylate/acrylic acid)/ | |
| | tert-butyl hydroperoxide | |
| Polymer | polystyrene seed (32 NV %**) | 1.05 |
| seed | | |
| Initiator | ammonium persulfate/ | 0.23/0.0 |
| | deionized-water | |
| Feed 1 | styrene/n-butyl acrylate | 25.2/26.3 |
| Feed 2 | diacetone acrylamide | 1.95/0.0 |
| | (20 wt. % solution)/ | |
| | deionized-water | |
| Feed 3 | methyl methacrylate/ | 22.3/24.2 |
| | n-butyl acrylate | |
| Redox | sodium erythorbate (12 wt. % | 0.15/0.0 |
| | solution)/de-ionized-water | |
| Post- | ammonium hydroxide (4.2 wt. % | 0.0/0.0/0.75 |
| additions | solution)/deionized-water/ | |
| | adipic acid dihydrazide | |

*non-volatile parts per hundred monomer
**NV % is non-volatile %

Example 2: The process for preparing polymer emulsion began by preparing an initial pot charge of diluted resin dispersion (Table 2) which was then agitated while heating to the reaction temperature of 88° C. Once the pot charge had reached a temperature of 80° C., tert-butyl hydroperoxide was charged to the reactor, and the mixture was held for one minute. Persulfate initiator solution (38.5 vol. % of total) and the polymer seed (Table 2) were then charged to the reactor. After holding for 15 minutes, monomer feeds 1 and 2 (Table 2) were started; all of feed 1 (Table 2) and half of feed 2 (Table 2) were charged to the reactor over 50 minutes. After 50 minutes, monomer feed 2 (Table 2) was paused for 10 minutes. A shot of persulfate initiator solution (30.8 vol. % of total) was then charged to the reactor, monomer feed 2 (Table 2) was resumed, and monomer feed 3 (Table 2) was started. The remainder of monomer feed 2 (Table 2) and all of monomer feed 3 (Table 2) were charged to the reactor over 50 minutes. After the completion of monomer feeds 2 and 3 (Table 2), a final shot of persulfate initiator solution (30.8 vol. % of total) was charged to the reactor and the reaction was held at temperature for 90 minutes. The reducer (sodium erythrobate) solution was then fed over 10 minutes, the reactor was cooled to room temperature, and the post-adds (Table 2) were charged to the reactor. The final emulsion was poured into collection containers through a 150 μm mesh to filter and measure the presence of large impurities/grit.

TABLE 2
Polymer Emulsion of Example 2

| Component | Composition | pphm* |
|---|---|---|
| Pot charge | deionized-water/ | 0.0/11.6/0.12 |
| | 30 wt. % of resin dispersion | |
| | (methyl methacrylate/styrene/ | |
| | n-butyl acrylate/acrylic acid)/ | |
| | tert-butyl hydroperoxide | |
| Polymer | polystyrene seed (32 NV %**) | 1.05 |
| seed | | |
| Initiator | sodium persulfate/deionized-water | 0.23/0.0 |
| Feed 1 | methyl methacrylate/n-butyl acrylate | 27.8/23.2 |
| Feed 2 | diacetone acrylamide (20 wt. % | 3.04/0.0 |
| | solution)/deionized-water | |
| Feed 3 | methyl methacrylate/n-butyl | 22.3/24.2/0.25 |
| | acrylate/tert-dodecylmercaptan | |
| Redox | sodium erythorbate (12 wt. % | 0.15/0.0 |
| | solution)/deionized-water | |
| Post- | ammonium hydroxide (4.2 wt. % | 0.0/0.0/0.75 |
| additions | solution)/deionized-water/adipic | |
| | acid dihydrazide | |

*non-volatile parts per hundred monomer
**NV % is non-volatile %

Example 3: The process for preparing polymer emulsion began by preparing an initial pot charge of diluted resin dispersion (Table 3), which was then agitated while heating to the reaction temperature of 88° C. Once the pot charge had reached a temperature of 80° C., tert-butyl hydroperoxide was charged to the reactor, and the mixture was held for one minute. Persulfate initiator solution (44 vol. % of total) and the polymer seed were then charged to the reactor. After holding for 15 minutes, monomer feeds 1 and 2 (Table 3) were started; all of feed 1 (Table 3) and half of feed 2 (Table 3) were charged to the reactor over 50 minutes. After 50 minutes, monomer feed 2 (Table 3) was paused for 10 minutes. A shot of persulfate initiator solution (28 vol. % of total) was then charged to the reactor, monomer feed 2 (Table 3) was resumed, and monomer feed 3 (Table 3) was started. The remainder of monomer feed 2 (Table 3) and all of monomer feed 3 (Table 3) were charged to the reactor over 50 minutes. After the completion of monomer feeds 2 and 3 (Table 3), a final shot of persulfate initiator solution (28 vol. % of total) was charged to the reactor and the reaction was held at temperature for 90 minutes. The reducer (sodium erythro-bate) solution was then fed over 10 minutes, the reactor was cooled to room temperature, and the post-adds (Table 3) were charged to the reactor. The final emulsion was poured into collection containers through a 150 μm mesh to filter and measure the presence of large impurities/grit.

TABLE 3
Polymer Emulsion of Example 3

| Component | Composition | pphm* |
|---|---|---|
| Pot charge | deionized-water/ | 0.0/11.6/0.12 |
| | 30 wt. % of resin dispersion | |
| | (methyl methacrylate/styrene/ | |
| | n-butyl acrylate/acrylic acid)/ | |
| | tert-butyl hydroperoxide | |
| Polymer | polystyrene seed (32 NV %**) | 1.05 |
| seed | | |
| Initiator | ammonium persulfate/deionized- | 0.23/0.0 |
| | water | |
| Feed 1 | styrene/methyl methacrylate | 25.1/26.6 |
| Feed 2 | diacetone acrylamide (20 wt. % | 1.95/0.0 |
| | solution)/deionized-water | |
| Feed 3 | methyl methacrylate/n-butyl | 22.2/24.1 |
| | acrylate | |
| Redox | sodium erythorbate (12 wt. % | 0.15/0.0 |
| | solution)/deionized-water | |
| Post- | ammonium hydroxide (4.2 wt. % | 0.0/0.0/0.75 |
| additions | solution)/deionized-water/adipic | |
| | acid dihydrazide | |

*non-volatile parts per hundred monomer
**NV % is non-volatile %

Example 4: The process of preparation of polymer emulsion began by preparing an initial pot charge of diluted resin dispersion (Table 4), which was then agitated while heating to the reaction temperature of 88° C. Once the pot charge had reached a temperature of 80° C., tert-butyl hydroperoxide was charged to the reactor, and the mixture was held for one minute. Persulfate initiator solution (44 vol. % of total) and the polymer seed were then charged to the reactor. After holding for 15 minutes, monomer feeds 1 and 2 (Table 4) were started; all of feed 1 (Table 4) and half of feed 2 (Table 4) were charged to the reactor over 50 minutes. After 50 minutes, monomer feed 2 (Table 4) was paused for 10 minutes. A shot of persulfate initiator solution (28 vol. % of total) was then charged to the reactor, monomer feed 2 (Table 4) was resumed, and monomer feed 3 (Table 4) was started. The remainder of monomer feed 2 (Table 4) and all of monomer feed 3 (Table 4) were charged to the reactor over 50 minutes. After the completion of monomer feeds 2 and 3 (Table 4), a final shot of persulfate initiator solution (28 vol. % of total) was charged to the reactor and the reaction was held at temperature for 90 minutes. The reducer (sodium erythrobate) solution was then fed over 10 minutes, the reactor was cooled to room temperature, and the post-adds (Table 4) were charged to the reactor. The final emulsion was poured into collection containers through a 150 μm mesh to filter and measure the presence of large impurities/grit.

TABLE 4
Polymer Emulsion of Example 4

| Component | Composition | pphm* |
|---|---|---|
| Pot charge | deionized-water/ | 0.0/10.0/0.12 |
| | 30 wt. % of resin dispersion | |
| | (n-butyl acrylate/acrylic acid)/ | |
| | tert-butyl hydroperoxide | |
| Polymer | polystyrene seed (32 NV %**) | 1.05 |
| seed | | |
| Initiator | ammonium persulfate/deionized- | 0.23/0.0 |
| | water | |
| Feed 1 | methyl methacrylate/n-butyl | 21.7/46.9 |
| | acrylate | |
| Feed 2 | diacetone acrylamide (20 wt. % | 2.5/0.0 |
| | solution)/deionized-water | |
| Feed 3 | methyl methacrylate/n-butyl | 21.4/7.6 |
| | acrylate | |
| Redox | sodium erythorbate (12 wt. % | 0.15/0.0 |
| | solution)/deionized-water | |
| Post- | ammonium hydroxide (4.2 wt. % | 0.0/0.0/0.75 |
| additions | solution)/deionized-water/adipic | |
| | acid dihydrazide | |

*non-volatile parts per hundred monomer
**NV % is non-volatile %

Example 5: The process of preparation of the polymer emulsion began by preparing an initial pot charge of diluted resin dispersion (Table 5), which was then agitated while heating to the reaction temperature to 88° C. Once the pot charge had reached a temperature of 80° C., tert-butyl hydroperoxide was charged to the reactor, and the mixture was held for one minute. Persulfate initiator solution (38.5 vol. % of total) and the polymer seed were then charged to the reactor. After holding for 15 minutes, monomer feed 1 (Table 5) was started; all of feed 1 (Table 5) was charged to the reactor over 100 minutes. After 50 minutes, a shot of persulfate initiator solution (30.8 vol. % of total) was then charged to the reactor. After the completion of monomer feed 1 (Table 5), a final shot of persulfate initiator solution (30.8 vol. % of total) was charged to the reactor and the reaction was held at temperature for 60 minutes. The reducer (sodium erythro-bate) solution was then fed over 10 minutes, the reactor was cooled to room temperature, and the post-adds (Table 5) were charged to the reactor. The final emulsion was poured into collection containers through a 150 μm mesh to filter and measure the presence of large impurities/grit.

TABLE 5
Polymer Emulsion of Example 5

| Component | Composition | pphm* |
|---|---|---|
| Pot charge | deionized-water/ | 0.0/11.3/0.12 |
| | 30 wt. % of resin dispersion | |
| | (methyl methacrylate/styrene/ | |
| | n-butyl acrylate/acrylic acid)/ | |
| | tert-butyl hydroperoxide | |
| Polymer | polystyrene seed (32 NV %**) | 1.05 |
| seed | | |
| Initiator | ammonium persulfate/deionized- | 0.23/0.0 |
| | water | |
| Feed 1 | methyl methacrylate/n-butyl | 43/51.3/5.7 |
| | acrylate/acetoacetoxyethyl | |
| | methacrylate | |
| Redox | sodium erythorbate (12 wt. % | 0.15/0.0 |
| | solution)/deionized-water | |
| Post- | ammonium hydroxide (4.2 wt. % | 0.0/0.0 |
| additions | solution)/deionized-water | |

*non-volatile parts per hundred monomer
**NV % is non-volatile %

Example 6: The process of preparing the polymer emulsion began by preparing an initial pot charge of diluted resin (Table 6) dispersion and the polymer seed (Table 6), which was then agitated while heating to the reaction temperature to 88° C. Once the pot charge had reached a temperature of 80° C., tert-butyl hydroperoxide was charged to the reactor, and the mixture was held for one minute. Persulfate initiator solution (38 vol. % of total) and was then charged to the reactor. After holding for 15 minutes, monomer feed 1 (Table 6) was started; all of feed 1 (Table 6) was charged to the reactor over 50 minutes. A shot of persulfate initiator solution (31 vol. % of total) was then charged to the reactor, holding for 10 minutes before starting monomer feed 2 (Table 6). Monomer feed 2 (Table 6) was charged to the reactor over 50 minutes. After the completion of monomer feed 2 (Table 6), a final shot of persulfate initiator solution (31 vol. % of total) was charged to the reactor and the reaction was held at temperature for 60 minutes. The reducer (sodium erythrobate) solution was then fed over 10 minutes, the reactor was cooled to room temperature, and the post-adds (Table 6) were charged to the reactor. The final emulsion was poured into collection containers through a 150 μm mesh to filter and measure the presence of large impurities/grit.

TABLE 6
Polymer Emulsion of Example 6

| Component | Composition | pphm* |
|---|---|---|
| Pot charge | deionized-water/ | 0.0/11.1/0.12 |
| | 30 wt. % of resin dispersion | |
| | (n-butyl acrylate/acrylic acid)/ | |
| | tert-butyl hydroperoxide | |
| Polymer | polystyrene seed (32 NV %**) | 1.05 |
| seed | | |
| Initiator | ammonium persulfate/deionized- | 0.40/0.0 |
| | water | |
| Feed 1 | styrene/n-butyl acrylate | 20.1/29.9 |
| Feed 2 | isobutyl methacrylate/n-butyl | 20.1/29.9 |
| | acrylate | |
| Redox | sodium erythorbate (12 wt. % | 0.15/0.0 |
| | solution)/deionized-water | |
| Post- | deionized-water | 0.0 |
| additions | | |

*non-volatile parts per hundred monomer
**NV % is non-volatile %

Comparative Example 1: The process of preparing the polymer emulsion began by preparing an initial pot charge of diluted resin dispersion (Table 7), which was then agitated while heating to the reaction temperature of 88° C. Once the pot charge had reached a temperature of 80° C., tert-butyl hydroperoxide was charged to the reactor, and the mixture was held for one minute. Persulfate initiator solution (38.5 vol. % of total) was then charged to the reactor. After holding for 15 minutes, monomer feeds 1 and 2 (Table 7) were started; all of feed 1 (Table 7) and half of feed 2 (Table 7) were charged to the reactor over 50 minutes. After 50 minutes, monomer feed 2 (Table 7) was paused for 10 minutes. A shot of persulfate initiator solution (30.8 vol. % of total) was then charged to the reactor, monomer feed 2 (Table 7) was resumed, and monomer feed 3 (Table 7) was started. The remainder of monomer feed 2 (Table 7) and all of monomer feed 3 (Table 7) were charged to the reactor over 50 minutes. After the completion of monomer feeds 2 and 3 (Table 7), a final shot of persulfate initiator solution (30.8 vol. % of total) was charged to the reactor and the reaction was held at temperature for 90 minutes. The reducer (sodium erythro-bate) solution was then fed over 10 minutes, the reactor was cooled to room temperature during which the dispersion destabilized and became solid. The final emulsion could not be filtered through a 150 μm mesh and was discarded without further characterization.

TABLE 7
Polymer Emulsion of Comparative Example 1

| Component | Composition | pphm* |
|---|---|---|
| Pot charge | deionized-water/ | 0.0/11.6/0.12 |
| | 30 wt. % of resin dispersion | |
| | (methyl methacrylate/styrene/ | |
| | n-butyl acrylate/acrylic acid)/ | |
| | tert-butyl hydroperoxide | |
| Initiator | sodium persulfate/deionized- | 0.23/0.0 |
| | water | |
| Feed 1 | methyl methacrylate/n-butyl | 27.8/23.2 |
| | acrylate | |
| Feed 2 | diacetone acrylamide (20 wt. % | 3.04/0.0 |
| | solution)/deionized-water | |
| Feed 3 | methyl methacrylate/n-butyl | 22.3/24.2/0.25 |
| | acrylate/Tert-dodecylmercaptan | |
| Redox | sodium erythorbate (12 wt. % | 0.15/0.0 |
| | solution)/deionized-water | |
| Post- | ammonium hydroxide (4.2 wt. % | 0.0/0.0/0.75 |
| additions | solution)/deionized-water/adipic | |
| | acid dihydrazide | |

*non-volatile parts per hundred monomer

Comparative Example 2: The procedure began by preparing an initial pot charge of water (Table 8), which was then agitated while heating to the reaction temperature to 75° C. Once the pot charge had reached a temperature of 75° C., tert-butyl hydroperoxide was charged to the reactor, and the mixture was held for one minute before increasing temperature to 85° C. Persulfate initiator solution (24.5 vol. % of total) and was then charged to the reactor. After holding for 5 minutes, monomer and persulfate initiator feeds were started and fed over 160 minutes. 20 minutes after starting the monomer and initiator feeds, the support resin feed (Table 8) was started and fed over 160 minutes. After 80 minutes through the monomer feed 1 (Table 8), temperature was increased to 90° C., and at completion of the monomer feed 1 (Table 8) the temperature was increased to 95° C. After completion of the support resin feed (Table 8), the reaction contents continued heating at 95° C. for 60 minutes. The reducer (sodium erythrobate) solution was then fed over 10 minutes, the reactor was cooled to room temperature, and the post-adds (Table 8) were charged to the reactor. The final emulsion was poured into collection containers through a 150 μm mesh.

TABLE 8
Polymer Emulsion of Comparative Example 2

| Component | Composition | pphm* |
|---|---|---|
| Pot charge | deionized-water/ | 0.0/0.12 |
| | tert-butyl hydroperoxide | |
| Support | 30 wt. % resin dispersion | 11.3 |
| resin | (n-butyl acrylate/acrylic acid) | |
| Initiator | Ammonium persulfate/deionized- | 0.38/0.0 |
| | water | |
| Monomer | methyl acrylate/n-butyl acrylate/ | 10.0/80.0/10.0 |
| Feed 1 | methyl methacrylate | |
| Redox | sodium erythorbate (12 wt. % | 0.15/0.0 |
| | solution)/deionized-water | |
| Post- | deionized-water | 0.0 |
| additions | | |

*non-volatile parts per hundred monomer

TABLE 9
Properties of the Polymer Emulsion

| | | | Non- | | | | |
|---|---|---|---|---|---|---|---|
| | | | volatiles | | | | Particle |
| | Resin | Resin | (NV) | Viscosity | Dv | Dn | Size |
| Example | Dispersion | (pphm) | (%) | (cps) | (nm) | (nm) | Distribution |
| Example 1 | n-butyl acry- | 10 | 60 | 934 | 738 | — | Bimodal |
| | late/acrylic acid | | | | | | |
| Example 2 | methyl methacry- | 11.6 | 62 | 715 | 401 | 110 | Bimodal |
| | late/styrene/n-butyl | | | | | | |
| | acrylate/acrylic acid | | | | | | |
| Example 3 | methyl methacry- | 11.5 | 66.5 | 814 | 361 | 255 | Bimodal |
| | late/styrene/n-butyl | | | | | | |
| | acrylate/acrylic acid | | | | | | |
| Example 4 | n-butyl acry- | 10 | 61.6 | 428 | 379 | 113 | Bimodal |
| | late/acrylic acid | | | | | | |
| Example 5 | methyl methacry- | 11.3 | 63.7 | 355 | 377 | 217 | Bimodal |
| | late/styrene/n-butyl | | | | | | |
| | acrylate/acrylic acid | | | | | | |
| Example 6 | n-butyl acry- | 11.1 | 57.1 | 164 | 211 | 96 | Bimodal |
| | late/acrylic acid | | | | | | |
| Comparative | methyl methacry- | 11.6 | N/A | Solid | N/A | N/A | Coagulated |
| Example 1 | late/styrene/n-butyl | | | | | | |
| | acrylate/acrylic | | | | | | |
| Comparative | n-butyl acry- | 11.1 | 59.7 | 160 | 662 | 162 | Bimodal |
| Example 2 | late/acrylic acid | | | | | | |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising”, and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

### DISCUSSION OF RESULTS

The results in Table 9 shows high solids content in the polymer emulsion prepared by the process according to the presently claimed invention. Examples produced using the process of the presently claimed invention (Examples 1 to 6) demonstrates that the addition of a polymer seed to a resin-stabilized emulsion polymerization that resulted in a bimodal particle size distribution, and thus enables the production of high solids content (NV %) of at least 55 wt. % and resin-stabilized latex with low viscosity (≤1000 cPs).

For comparison, the process of Example 2 was repeated without a polymer seed, described by Comparative Example 1, which resulted in extremely high viscosity to the point of solidification. This demonstrates the limitation of NV % in traditional resin-stabilized systems, and the advantage of the presently claimed process.

A second comparative example, Comparative Example 2, demonstrates the process in which the resin is semi-batch fed to the reaction, ultimately resulting in a bimodal particle size distribution. This Comparative Example 2 differs from the presently claimed process in use of a polymer seed, and that the resin is fed separately to the reactor. The presently claimed process is an improved process of preparing polymer emulsion that eliminates the need of protective colloids that require large amount of stabilizer, thereby limiting the water resistance properties. Further, polymer emulsions containing protective colloids and high solid content of more than 55 wt. % also have a disadvantage of poor rheological properties and are too highly viscous and consequently unsuitable for coating.

The improved properties of the polymer emulsion prepared by the presently claimed invention is driven by the ratio of the weight of the polymer seed to the weight of the resin. However, this is not the only parameter that drives the properties of the polymer emulsion. The addition of a resin stabilizer prepared by the continuous free radical polymerization process to the reaction mixture to prepare polymer emulsion also enables unique properties and morphologies. The particle size distribution is a factor that affects the viscosity and the adhesive properties of the polymer emulsion. The optimization of the components of the reaction mixture in the process disclosed herein drives the desired particle size distribution. A relatively narrow particle size distribution as shown in Table 9 has a substantial influence in achieving the desired adhesive properties.

Test Methods

Molecular weight determination: Gel permeation chromatography (GPC) spectra were acquired with a Waters 2695 instrument and was used to determine molecular weight of polymers using tetrahydrofuran (THF) as the mobile phase at 40° C. and a RI detector. All samples were analysed for number average molecular weight (Mn) and weight average molecular weight (Mw), using elution times calibrated against polystyrene molecular weight standards. The number average molecular weight (Mn) is the statistical average molecular weight of all the polymer chains in the polymer and is defined by:

Mₙ=(ΣNᵢMᵢ)/ΣNᵢ

where Mi is the molecular weight of a chain and Ni is the number of chains of that molecular weight.

The weight average molecular weight (Mw) is defined by:

M_{w}=(ΣNᵢMᵢ²)/ΣNᵢ

Compared to Mn, Mw considers the molecular weight of a chain in determining contributions to the molecular weight average. The more massive the chain, the more the chain contributes to Mw.

Higher average molecular weights (Mz) can be defined by the equation:

M_{z}=(ΣNᵢMᵢ³)/ΣNᵢ

Solid content determination: The solid content of the polymer emulsion was measured gravimetrically by drying about 0.5 g to about 2 g sample of dispersions in a 140° C. oven for 1 hour. The solids content was measured using a CEM microwave solids tester. The non-volatile (NV %) amount was measured gravimetrically using a CEM Smart System 5 Microwave Moisture Analyzer.

Viscosity determination: The viscosity of the polymer emulsion was determined with a Brookfield RV viscometer at 60 RPM (spindle 63).

Particle size determination including volume average particle size: Particle size of the particles in the polymer emulsion were measured using a nano-flex particle sizer from Microtrac using Dynamic Light Scattering technique.

Glass Transition Temperature determination: Glass transition temperature (Tg) was measured by Differential Scanning calorimetry (DSC) using a heat-cool-heat method according to ASTM D 3418-12e1.

1.-27. (canceled)

28. A process for preparing a polymer emulsion comprising the steps of:
i) providing a resin dispersion comprising at least one resin in water;
ii) adding at least one polymer seed and a polymerization mixture to the resin dispersion, said polymerization mixture comprising at least one co-polymerizable monomer; and
iii) preparing a polymer emulsion in water by radical emulsion polymerization of the polymerization mixture, the resin dispersion and the polymer seed;
wherein the polymer emulsion has a solids content of at least 55 wt. %, based on the total weight of the polymer emulsion.

29. The process according to claim 28, further comprising the step of adding at least one surfactant to the resin dispersion in an amount in the range of ≤0.10 wt. %, based on the total weight of the polymer emulsion.

30. The process according to claim 28, wherein the at least one resin is selected from the group of polyacrylates, polymethacrylates, and polystyrenes.

31. The process according to claim 28, wherein the at least one resin is present in an amount in the range of from 5 wt. % to 40 wt. %, based on the total weight of the resin dispersion.

32. The process according to claim 28, wherein the at least one polymer seed is selected from the group of polystyrene, poly(meth)acrylate, vinyl acetate polymer, ethylene vinyl acetate polymer, acrylic polymer, vinyl acrylic polymer and styrene (meth)acrylic polymer.

33. The process according to claim 28, wherein the at least one polymer seed comprises ≤1.0 wt. % of at least one acid monomer, based on the total weight of the at least one polymer seed.

34. The process according to claim 33, wherein the at least one acid monomer is selected from the group of ethylenically unsaturated carboxylic acids, ethylenically unsaturated sulfonic acids and vinylphosphonic acids.

35. The process according to claim 28, wherein the at least one polymer seed has a number average particle size diameter in the range of from 10 nm to 50 nm, determined according to dynamic light scattering method.

36. The process according to claim 28, wherein the at least one polymer seed has a weight average molecular weight in the range of from 10,000 g/mol to 500,000 g/mol, determined according to gel permeation chromatography.

37. The process according to claim 28, wherein the at least one polymer seed is present in an amount in the range of from 0.1 wt. % to 5.0 wt. %, based on the total weight of the polymer emulsion.

38. The process according to claim 28, wherein the at least one polymer seed has a solids content in the range of from 1.0 wt. % to 50.0 wt. %, based on the total weight of the polymer seed.

39. The process according to claim 28, wherein the at least one co-polymerizable monomer is selected from the group of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, styrene, α-methyl styrene, ethyl acrylate, n-propyl acrylate, iso-propyl acrylate, 1,4-butanediol diacrylate, n-butyl acrylate, n-butyl acrylate, iso-butyl acrylate, t-butyl acrylate, n-amyl acrylate, iso-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, hydroxyethyl acrylate, hydroxypropyl acrylate, hydroxybutyl acrylate, methyl methacrylate, ethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, glycidyl methacrylate, crotyl methacrylate, cyclohexyl methacrylate, cyclopentyl methacrylate, 2-ethoxyethyl methacrylate, isobornyl methacrylate, hydroxyethyl methacrylate, hydroxypropyl methacrylate, hydroxybutyl methacrylate, ureido methacrylate, acrylamide, methacrylamide, N-butoxymethyl methacrylamide, N-methylol acrylamide, N-methylol methacrylamide, diacetone acrylamide, vinyl acetate, and acrylonitrile.

40. The process according to claim 28, wherein the at least one co-polymerizable monomer has a theoretical weight average molecular weight in the range of from 50 g/mol to 500 g/mol.

41. The process according to claim 39, wherein the at least one co-polymerizable monomer is present in an amount in the range of from 15 wt. % to 65 wt. %, based on the total weight of the polymer emulsion.

42. The process according to claim 28, wherein the polymerization mixture further comprises at least one water-soluble initiator.

43. The process according to claim 42, wherein the at least one water-soluble initiator is selected from the group of ammonium or alkali metal salts of peroxodisulfuric acid, and peroxides.

44. The process according to claim 42, wherein the at least one water-soluble initiator is present in an amount in the range of from 0.10 wt. % to 5.0 wt. %, based on the total weight of the monomers in the polymerization mixture.

45. The process according to claim 28, wherein the weight ratio of the at least one polymer seed to the at least one co-polymerizable monomer is in the range of from 0.2:100 to 5:100.

46. The process according to claim 28, wherein the weight ratio of the at least one resin to the at least one co-polymerizable monomer is in the range of from 5:100 to 40:100.

47. The process according to claim 28, wherein the polymer emulsion has a solids content of at least 60 wt. % based on the total weight of the polymer emulsion.

48. The process according to claim 28, wherein the polymer emulsion has a glass transition temperature in the range of from −60° C. to 120° C., determined according to dynamic scanning calorimetry.

49. The process according to claim 28, wherein the polymer emulsion has a viscosity in the range of from 50 cps to 10,000 cps, measured using a viscometer with a #63 spindle, 60 RPM at 25° C.

50. The process according to claim 28, wherein the polymer emulsion contains particles that have a volume average particle size diameter in the range of from 100 nm to 1000 nm, determined according to dynamic light scattering method.

51. The process according to claim 28, wherein the step of preparing a polymer emulsion in water by radical emulsion polymerization is a semi-batch process.

52. The process according to claim 50, wherein the polymer emulsion comprises particles present in a bimodal or a multimodal particle size distribution.

53. A polymer emulsion obtainable by the process according to claim 28.

54. The polymer emulsion according to claim 53, wherein the polymer emulsion is suitable in preparation of adhesives, composite films, protective film lamination, coatings, sound damping, primers, inks or pigment dispersions.
